(19) United States
(12) Patent Application Publication
(10) Pub. No.: US 2013/0203449 A1
(43) Pub. Date: Aug. 8, 2013

(54) APPARATUS AND METHOD FOR REDUCING PAGING CHANNEL LOAD IN A WIRELESS NETWORK

(71) Applicant: Qualcomm Incorporated, San Diego, CA (US)

(72) Inventors: Edward George Tiedemann, JR., Concord, MA (US); Ravindra Manohar Patwardhan, San Diego, CA (US); Rashid Ahmed Akbar Attar, San Diego, CA (US)

(73) Assignee: Qualcomm Incorporated, San Diego, CA (US)

(21) Appl. No.: 13/753,201

(22) Filed: Jan. 29, 2013

Related U.S. Application Data
(60) Provisional application No. 61/594,892, filed on Feb. 3, 2012.
(60) Provisional application No. 61/595,115, filed on Feb. 5, 2012.

(51) Int. Cl. H04W 68/02

(52) U.S. Cl. CPC H04W 68/02
USPC 455/458

(57) ABSTRACT

Apparatus and methods are described herein for monitoring multiple paging channels at a mobile station. A mobile station may monitor a primary paging channel and an optimized secondary paging channel to receive signals from a base station. The mobile station may process overhead data messages received in signals over the primary paging channel. The mobile station may process any mobile-station specific messages received in signals over the optimized secondary paging channel. Other aspects, embodiments, and features are also claimed and described.

### CLAIM OF PRIORITY UNDER 35 U.S.C. §119

The present application for patent claims priority to U.S. Provisional Application No. 61/594,892 entitled “Apparatus and Method for Reducing Paging Channel Load in a Wireless Network” filed Feb. 3, 2012, and to U.S. Provisional Application No. 61/595,115 entitled “Apparatus and Method for Reducing Paging Channel Load in a Wireless Network” filed Feb. 5, 2012, both of which are assigned to the assignee hereof and hereby expressly incorporated by reference herein as if fully set forth below and for all applicable purposes.

### TECHNICAL FIELD

The technology discussed in this patent application relates generally to wireless communication, and more specifically to, devices, systems, and methods for reducing paging channel load in a network. Embodiments of the present can aid to reduce network congestion ensuring functioning network operations.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems (e.g., cdma2000 1x (IS-2000)), time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple mobile stations (MS). Each MS communicates with one or more base stations (BS), such as a Node B or other access point, via transmissions on the forward and reverse links. The forward link (or downlink) refers to the communication link from the BSs to the MSs, and the reverse link (or uplink) refers to the communication link from the MSs to the BSs.

BSs can communicate signals to MSs over a paging channel, including system overhead signals, paging signals to page the MSs when a call or other data is present for consumption by the MSs, and/or the like. In some networks, such as 1x, deployment of multiple paging channels are permitted for a given BS or related cell. For example, the BS can employ secondary paging channels where a paging load is over a threshold on a primary paging channel. The BS transmits overhead messages, such as system information messages (e.g., messages in the CONFIG_MSG_SEQ and ACC_MSG_SEQ groups in 1x) as well as MS-specific messages, over each of the multiple paging channels to facilitate communicating with multiple MSs. This can cause increased paging load at the network.

### BRIEF SUMMARY OF SOME EXAMPLE EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect, a method for monitoring multiple paging channels at a mobile station is described herein. The method comprises monitoring a primary paging channel and an optimized secondary paging channel to receive one or more signals from a base station; processing overhead data messages received in signals over the primary paging channel; and processing MS-specific messages received in signals over the optimized secondary paging channel.

In another aspect, a method for communicating over multiple paging channels from a base station is described herein. The method comprises generating one or more overhead messages; transmitting the one or more overhead messages over a primary paging channel; generating one or more mobile station (MS)-specific messages related to a MS; and transmitting the one or more MS-specific messages over an optimized secondary paging channel.

Other aspects include one or more of: a computer program product having a computer-readable medium including at least one instruction operable to cause a computer to perform the above-described methods; an apparatus including one or more means for performing the above-described methods; and an apparatus having a memory in communication with a processor that is configured to perform the above-described methods.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an example system for communicating over multiple paging channels in a wireless network according to some embodiments.

FIG. 2 illustrates example timelines for sending signals over multiple paging channels according to some embodiments.

FIG. 3 illustrates an example methodology for processing messages received over multiple monitored paging channels according to some embodiments.

FIG. 4 illustrates an example methodology for communicating messages over multiple paging channels according to some embodiments.

FIG. 5 illustrates an example system that processes messages received over multiple monitored paging channels according to some embodiments.

FIG. 6 illustrates an example system that communicates messages over multiple paging channels according to some embodiments.

FIG. 7 illustrates a multiple access wireless communication system according to one embodiment according to some embodiments.

FIG. 8 illustrates a block diagram of a communication system according to some embodiments.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to improving paging load on a wireless network. In some networks, a base station (BS) can utilize multiple paging channels to communicate overhead signals, paging signals, etc., to one or more mobile stations (MS). The BS can add secondary paging channels where a load on a primary paging channel is over a threshold. In this example, the BS can utilize the primary paging channel for transmitting certain types of messages, while using one or more secondary paging channels for transmitting other types of messages or a subset of the types of messages transmitted on the primary paging channel. In an example, the BS can transmit overhead messages (e.g., messages common to all or some MSs communicating with the BS) and/or paging and other MS-specific messages (also referred to as directed messages) over the primary paging channel, while communicating paging and other MS-specific messages, and not overhead or other common messages, over the secondary paging channel. Thus, overall paging load at the BS is decreased since the BS need not transmit overhead messages (or other common messages) over all paging channels.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, user equipment, or user equipment device. A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, access node, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

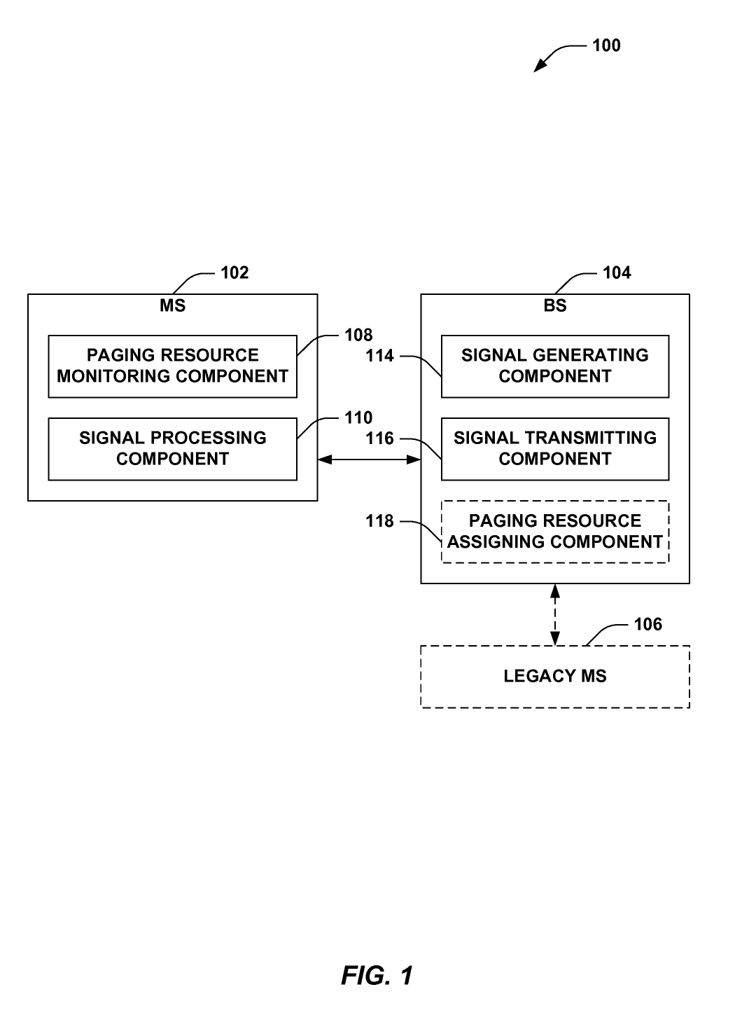

Referring to FIG. 1, a wireless communication system 100 is illustrated that facilitates utilizing multiple paging channels for communicating signals to one or more MSs. System 100 includes a MS 102 that communicates with a BS 104 to receive wireless network access. System 100 can also include a legacy MS 106 that can also communicate with the BS 104. MSs 102 and 106 can each be substantially any MS, modem (or other tethered device), machine-to-machine (M2M) device, an MS portion of a relay or other network component, and/or the like, that can receive and process paging signals in a wireless network. BS 104 can be substantially any type of BS, such as a macrocell, femtocell, picocell, or similar BS, a mobile BS, a relay, an MS communicating in peer-to-peer or ad-hoc mode with MS 102 or 106, and/or the like, that can communicate paging signals to MSs in a wireless network.

MS 102 can include a paging resource monitoring component 108 for obtaining signals communicated over one or more paging channels, and a signal processing component 110 for determining overhead messages or MS-specific messages transmitted in the one or more signals.

BS 104 can include a signal generating component 114 for creating one or more signals for transmitting to one or more MSs, a signal transmitting component 116 for transmitting the signals to the one or more MSs over one or more paging channels (also referred to as paging resources), and an optional paging resource assigning component 118 for indicating paging resources to one or more MSs over which to obtain one or more signals (e.g., and/or to signal transmitting component 116 for appropriately transmitting MS-specific signals to the one or more MSs).

According to an example, signal generating component 114 can generate one or more signals for transmitting over a paging channel resource. For example, in one aspect, the signals can represent an overhead message or another message carrying information common to MSs communicating with BS 104. For example, the overhead message can comprise system or network information regarding operating frequencies, logical channel structure, system acquisition parameters, and/or the like (e.g., messages in a CONFIG_MSG_SEQ or ACC_MSG_SEQ group in 1x). Signal transmitting component 116 can transmit the overhead messages or other common messages over a primary paging channel for retrieval and decoding by one or more MSs, such as MS 102 or 106.

In an additional or alternative example, in another aspect, signal generating component 114 can generate signals that are MS-specific, such as paging signals to page MSs to receive a call or other data, channel assignments, etc. In one example, signal transmitting component 116 can transmit the MS-specific signals over the primary paging channel or a secondary paging channel. In the described aspects, the secondary paging channel can be referred to as an optimized secondary paging channel. This is because the optimized secondary paging channel does not carry overhead or other common messages. In this respect, the secondary paging channel is optimized in that it includes MS directed messages. Thus, paging load may be reduced on a secondary paging channel since the described optimized secondary paging channel need not transmit overhead messages.

In this example, paging resource monitoring component 108 can monitor both the primary and optimized secondary paging channel for signals from BS 104. In this example, signal processing component 110 can process signals received over the primary paging channel, and decode the signals to retrieve the overhead data or other common messages. Similarly, signal processing component 110 can process signals received over the optimized secondary paging channel to obtain MS-specific messages, such as paging messages, channel assignments, etc.

Paging resource monitoring component 108, in one example, can simultaneously monitor the primary and optimized secondary paging channels (e.g., using dual receivers or other mechanisms to receive and process signals from both channels). In another example, paging resource monitoring component 108 can sequentially monitor the paging channels. In this example, paging resource monitoring component 108 can monitor the optimized secondary paging channel during assigned time slots, while monitoring the primary paging signal during time periods between or otherwise outside of the time slots for monitoring the secondary paging channel.

Thus, in one example, paging resource assigning component 118 can assign the optimized secondary paging channel and related time slots to MS 102. For example, this can include assigning using a slot cycle index (SCI) to indicate one or more time slots during which MS 102 can listen for MS-specific signals over the optimized secondary paging channel. For example, paging resource assigning component 118 can first determine whether the MS 102 is able to monitor more than one paging channel (e.g., based on parameters received from the MS 102 or in subscription data for the MS 102, such as a device version or communication capabilities). In one example MS 102 can indicate an ability to monitor more than one paging channel in or along with one or more other registration messages (RGM), origination response messages (ORM), paging response messages (PRM), general extension messages (GEM), etc., in 1x.

In an example, for legacy MS 106, paging resource assigning component 118 can determine that the legacy MS 106 does not support multiple paging channels (e.g., based on absence of the described parameters regarding an ability to monitor more than one paging channel, in subscription data or other messages), and thus paging resource assigning component 118 can assign resources on the primary paging channel for legacy MS 106. In this example, signal transmitting component 116 transmits MS-specific signals for legacy MS 106 only over the primary paging channel.

In another example, paging resource monitoring component 108 can monitor all paging channels operated by BS 104. Thus, paging channel capacity can be further increased by the flexibility to communicate over substantially any of multiple paging channels. Also, since signal transmitting component 116 can transmit MS-specific messages on any paging channel, a trunking gain (or multiplexing gain) can be achieved such that when the MS 106 is monitoring all paging channels, the BS 104 or network can use free paging channel capacity on each paging channel. Thus, the BS 104 or network can serve more users overall than the case where each user is assigned a single paging channel

In a specific example, paging resource assigning component 118 can utilize one or more parameters to indicate information regarding the paging channels to MS 102 and/or legacy MS 106. For example, paging resource assigning component 118 can indicate a number of paging channels in the system (e.g., using a PAGE_CHAN field). This can be used for legacy paging channels only, in one example, and the legacy MS 106 can hash to one of the primary paging channels. Paging resource assigning component 118 can add other fields for the optimized secondary paging channels, such as an ADD_PAGE_CHAN field to advertise the number of optimized secondary paging channels. The MS 102 can hash to one of the optimized secondary paging channels. In another example, paging resource assigning component 118 can advertise an indicator of whether to use all paging channels (e.g., USE_ALL_PAGE_CHAN field). If this value is set to true, MS 102 can hash on all paging channels of BS 104; otherwise, MS 102 can hash on optimized secondary paging channels.

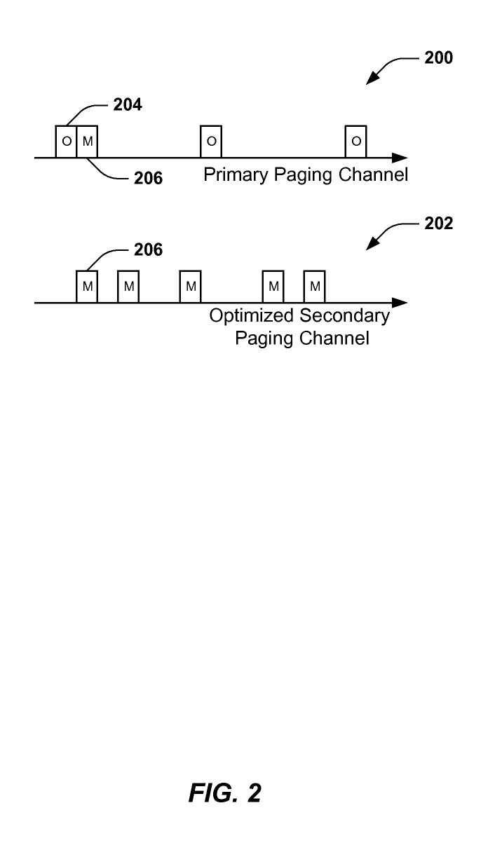

Turning now to FIG. 2, example timelines 200 and 202 for communicating over multiple paging channels are shown. Timelines 200 and 202 can occur within the same time, for example. Timeline 200 represents transmissions over a primary paging channel, and timeline 202 represents transmissions over an optimized secondary paging channel. For example, a BS can transmit overhead messages 204 (indicated “O”) over the primary paging channel while transmitting MS-specific messages 206 (indicated “M”) over the optimized secondary paging channel. The BS can assign different slots to the MS, in one example, for receiving paging signals, channel assignments, and/or the like. The BS can attempt to avoid transmitting overhead messages 204 in these slots where a corresponding MS is not able to simultaneously monitor both paging channels. In this example, the MS receiving the MS-specific messages over the optimized secondary paging channel can also receive the overhead messages over the primary paging channel in subsequent time slots. The BS does not transmit overhead messages on the optimized secondary paging channel, which can reduce paging load, as described.

Moreover, in an example, the BS can initially communicate over the primary paging channel without secondary paging channels until the primary paging channel becomes loaded beyond a threshold. In this example, the BS can utilize the primary paging channel to transmit MS-specific messages 206 along with the overhead messages 204. Once the primary paging channel becomes overloaded, however, the BS can move MS-specific messages to the optimized secondary paging channel, as represented at 202, to lessen the paging load on the primary paging channel. It is to be appreciated, however, that the BS can still transmit MS-specific messages 208 for legacy devices over the primary paging channel, as described, to provide backward compatibility with such devices.

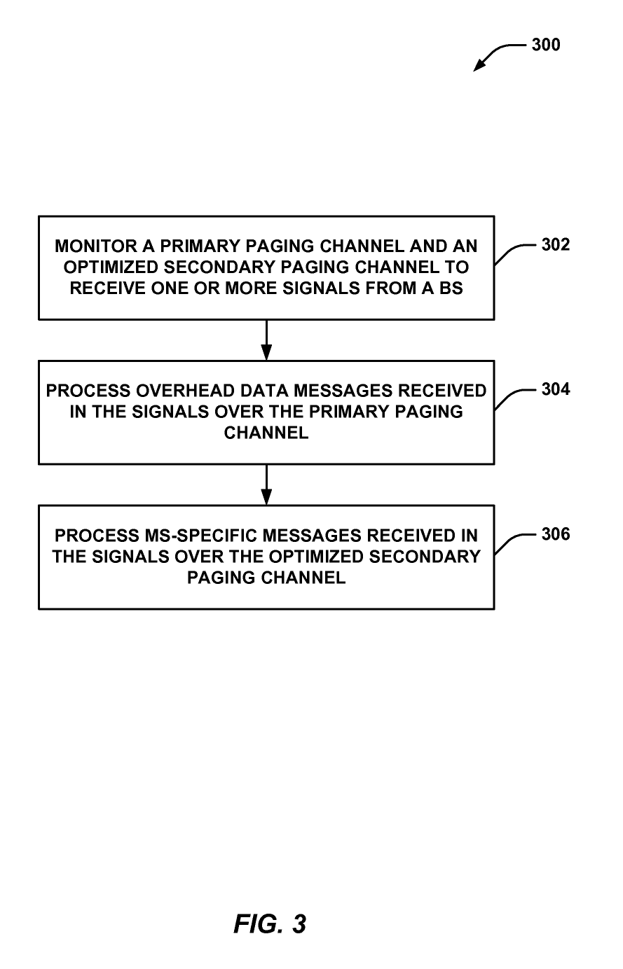

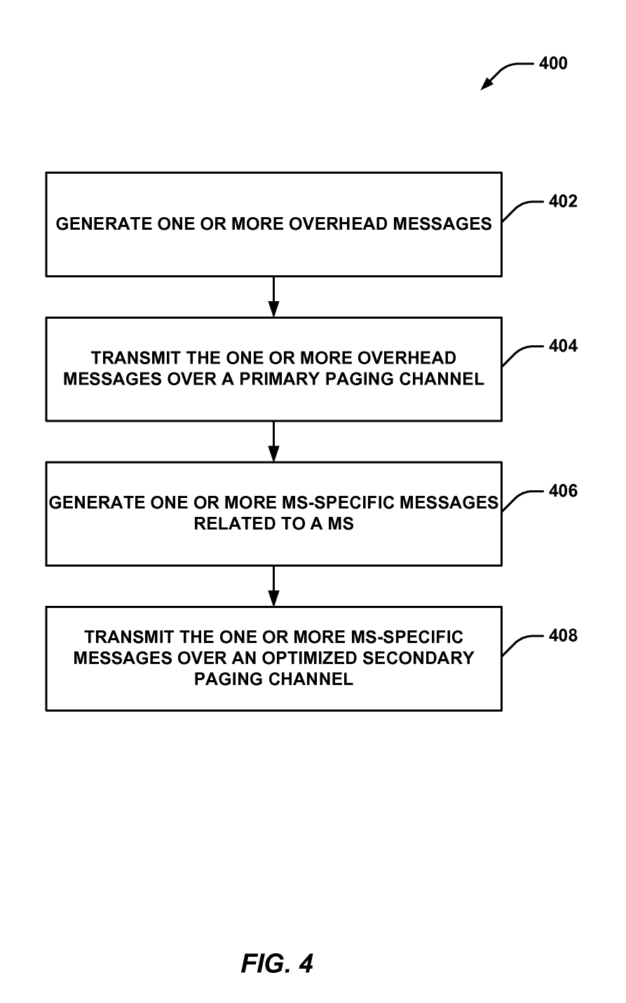

Referring to FIGS. 3-4, example methodologies for reducing paging load over a wireless network are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 3, an example methodology 300 that facilitates monitoring multiple paging channels is illustrated.

At 302, a primary paging channel and an optimized secondary paging channel can be monitored to receive one or more signals from a BS. The paging channels can be monitored simultaneously (e.g., using a plurality of receivers, or receiving signals over multiple frequencies) or sequentially (e.g., monitoring one of the paging channels in a given time slot). In one example, slots for the optimized secondary paging channel can be assigned over which the BS sends MS-specific messages, and thus monitoring at 302 can include monitoring the optimized secondary paging channel during these slots, while monitoring the primary paging channel during other slots.

At 304, overhead data messages received in the signals over the primary paging channel can be processed. As described, such messages can include system or network information messages (e.g., in a CONFIG_MSG_SEQ or ACC_MSG_SEQ group in 1x). The overhead messages can be used for determining information regarding the BS or communication parameters thereof, for example.

At 306, MS-specific messages received in the signals over the optimized secondary paging channel can be processed. For example, the MS-specific messages can include paging signals to receive a call or other data from the base station, channel assignments, and/or the like.

Turning to FIG. 4, an example methodology 400 is shown for communicating over multiple paging channels.

At 402, one or more overhead messages can be generated. The overhead messages can include messages for communicating system or network information (e.g., messages in a CONFIG_MSG_SEQ or ACC_MSG_SEQ group in 1x). The overhead messages can be messages common to MSs communicating with the BS such that transmitting the messages over one primary paging channel allows MSs to receive the messages without receiving explicit slot assignments over the primary paging channel.

At 404, the one or more overhead messages can be transmitted over the primary paging channel. This can include transmitting the overhead messages in periodic time slots. In addition, the time slots can be selected to avoid collision with transmission of MS-specific messages over other paging channels, in one example.

At 406, one or more MS-specific messages related to a MS can be generated. The MS-specific messages can include paging signals, channel assignments, and/or the like.

At 408, the one or more MS-specific messages can be transmitted over an optimized secondary paging channel. As described, slots on the optimized secondary paging channel over which the MS-specific messages are transmitted can be assigned to or otherwise associated with the MS.

It will be appreciated that, in accordance with one or more aspects described herein, inferences can be made regarding associating MSs with slots on the optimized secondary paging channels, determining whether a MS supports multiple paging channel monitoring, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

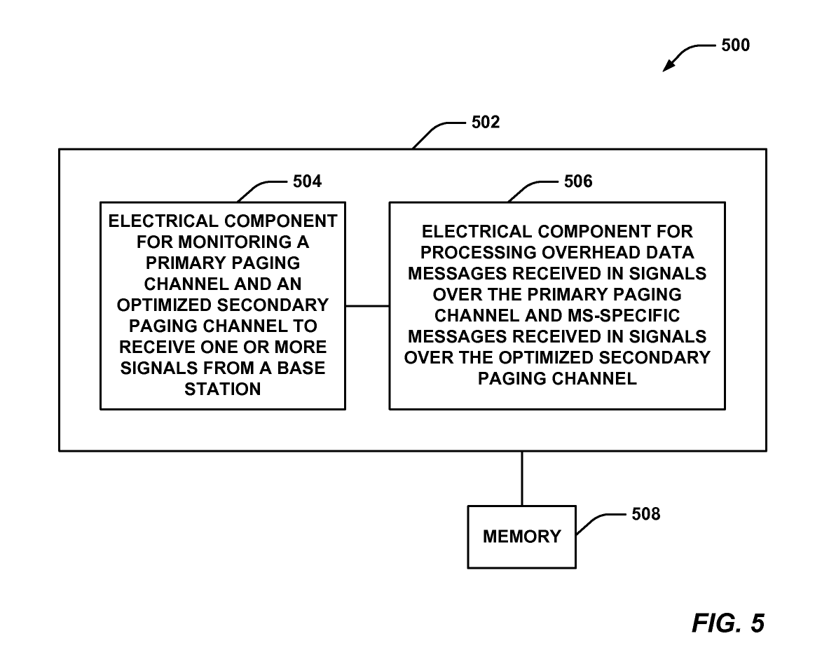

Turning now to FIG. 5, an example system 500 is displayed for monitoring multiple paging channels for relevant messages. For example, system 500 can reside at least partially within a device. It is to be appreciated that system 500 is represented as including functional blocks, which can be functional blocks that represent functions implemented by a processor, software, or combination thereof (e.g., firmware). System 500 includes a logical grouping 502 of electrical components that can act in conjunction. For instance, logical grouping 502 can include an electrical component for monitoring a primary paging channel and an optimized secondary paging channel to receive one or more signals from a base station 504. As described, this can include monitoring the paging channels simultaneously or sequentially.

Moreover, logical grouping 502 can include an electrical component for processing overhead data messages received in signals over the primary paging channel and MS-specific messages received in signals over the optimized secondary paging channel 506. The MS-specific messages can include paging messages, channel assignments, etc.

Moreover, electrical component 504 can comprise a paging resource monitoring component 108, electrical component 506 can comprise a signal processing component 110, etc., in one example. Additionally, system 500 can include a memory 508 that retains instructions for executing functions associated with the electrical components 504 and 506, stores data used or obtained by the electrical components 504, 506, etc. While shown as being external to memory 508, it is to be understood that one or more of the electrical components 504 and 506 can exist within memory 508. In one example, electrical components 504 and 506 can comprise at least one processor, or each electrical component 504 and 506 can be a corresponding module of at least one processor. Moreover, in an additional or alternative example, electrical components 504 and 506 can be a computer program product including a computer readable medium, where each electrical component 504 and 506 can be corresponding code.

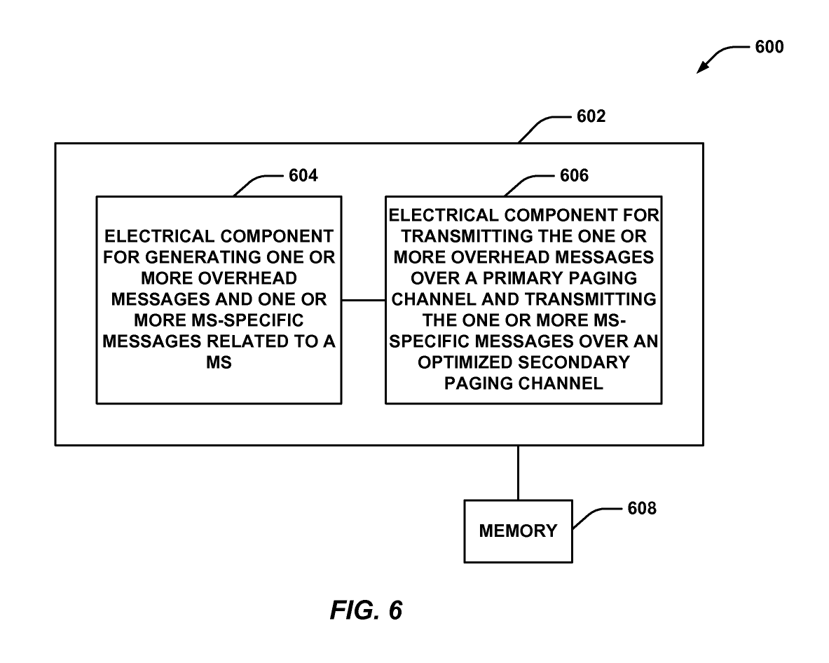

Turning now to FIG. 6, an example system 600 is displayed for communicating signals over multiple paging channels. For example, system 600 can reside at least partially within a network component, such as a base station. It is to be appreciated that system 600 is represented as including functional blocks, which can be functional blocks that represent functions implemented by a processor, software, or combination thereof (e.g., firmware). System 600 includes a logical grouping 602 of electrical components that can act in conjunction. For instance, logical grouping 602 can include an electrical component for generating one or more overhead messages and one or more MS-specific messages related to a MS 604. Moreover, logical grouping 602 can include an electrical component for transmitting the one or more overhead messages over a primary paging channel and transmitting the one or more MS-specific messages over an optimized secondary paging channel 606.

Moreover, electrical component 604 can include a signal generating component 114, electrical component 606 can include a signal transmitting component 116, and/or the like, as described above. Additionally, system 600 can include a memory 608 that retains instructions for executing functions associated with the electrical components 604 and 606, stores data used or obtained by the electrical components 604 and 606, etc. While shown as being external to memory 608, it is to be understood that one or more of the electrical components 604 and 606 can exist within memory 608. In one example, electrical components 604 and 606 can comprise at least one processor, or each electrical component 604 and 606 can be a corresponding module of at least one processor. Moreover, in an additional or alternative example, electrical components 604 and 606 can be a computer program product including a computer readable medium, where each electrical component 604 and 606 can be corresponding code.

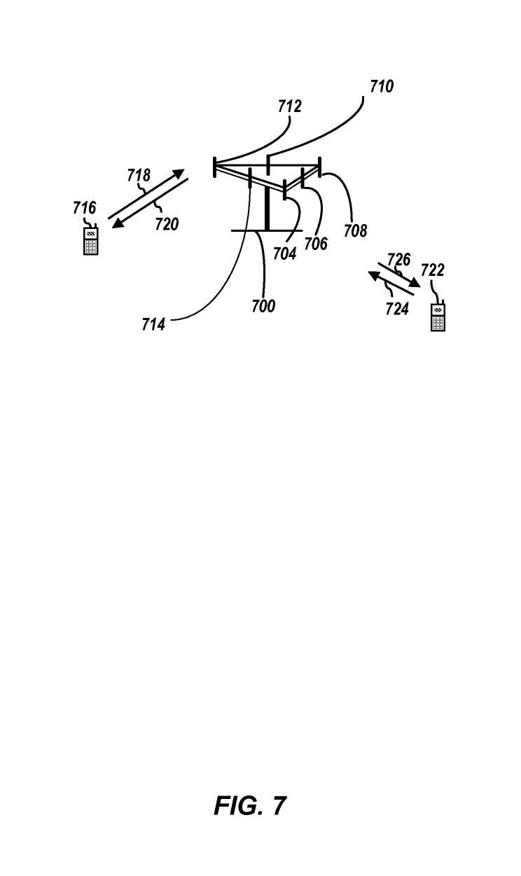

Referring to FIG. 7, a multiple access wireless communication system according to one embodiment is illustrated. An access point 700 (AP) includes multiple antenna groups, one including 704 and 706, another including 708 and 77, and an additional including 712 and 714. In FIG. 7, only two antennas are shown for each antenna group, however, more or fewer antennas can be utilized for each antenna group. Access terminal 716 (AT) is in communication with antennas 712 and 714, where antennas 712 and 714 transmit information to access terminal 716 over forward link 720 and receive information from access terminal 716 over reverse link 718. Access terminal 722 is in communication with antennas 704 and 706, where antennas 704 and 706 transmit information to access terminal 722 over forward link 726 and receive information from access terminal 722 over reverse link 724. In a FDD system, communication links 718, 720, 724 and 726 can use different frequency for communication. For example, forward link 720 can use a different frequency then that used by reverse link 718.

Each group of antennas and/or the area in which they are designed to communicate is often referred to as a sector of the access point. In the embodiment, antenna groups each are designed to communicate to access terminals in a sector of the areas covered by access point 700.

In communication over forward links 720 and 726, the transmitting antennas of access point 700 utilize beamforming in order to improve the signal-to-noise ratio of forward links for the different access terminals 716 and 722. Also, an access point using beamforming to transmit to access terminals scattered randomly through its coverage causes less interference to access terminals in neighboring cells than an access point transmitting through a single antenna to all its access terminals.

Moreover, access terminals 716 and 722 can provide functionality to monitor multiple paging channels of AP 700, as described above.

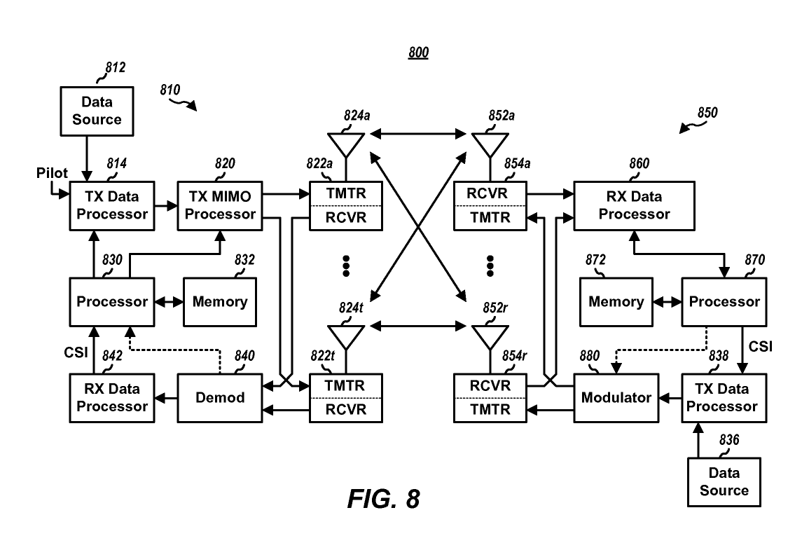

FIG. 8 is a block diagram of an embodiment of a transmitter system 810 (also known as the access point) and a receiver system 850 (also known as access terminal) in a MIMO system 800. At the transmitter system 810, traffic data for a number of data streams is provided from a data source 812 to a transmit (TX) data processor 814. In addition, it is to be appreciated that transmitter system 810 and/or receiver system 850 can employ the systems (FIGS. 1, 2, and 5-7) and/or methods (FIGS. 3 and 4) described herein to facilitate wireless communication there between. For example, components or functions of the systems and/or methods described herein can be part of a memory 832 and/or 872 or processors 830 and/or 870 described below, and/or can be executed by processors 830 and/or 870 to perform the disclosed functions.

In an embodiment, each data stream is transmitted over a respective transmit antenna. TX data processor 814 formats, codes, and interleaves the traffic data for each data stream based on a particular coding scheme selected for that data stream to provide coded data.

The coded data for each data stream can be multiplexed with pilot data using OFDM techniques. The pilot data is typically a known data pattern that is processed in a known manner and can be used at the receiver system to estimate the channel response. The multiplexed pilot and coded data for each data stream is then modulated (e.g., symbol mapped) based on a particular modulation scheme (e.g., BPS K, QSPK, M-PSK, or M-QAM) selected for that data stream to provide modulation symbols. The data rate, coding, and modulation for each data stream can be determined by instructions performed by processor 830.

The modulation symbols for all data streams are then provided to a TX MIMO processor 820, which can further process the modulation symbols (e.g., for OFDM).

TX MIMO processor 820 then provides N_{T} modulation symbol streams to N_{T} transmitters (TMTR) 822a through 822t. In certain embodiments, TX MIMO processor 820 applies beamforming weights to the symbols of the data streams and to the antenna from which the symbol is being transmitted.

Each transmitter 822 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 822a through 822t are then transmitted from N_{T} antennas 824a through 824t, respectively.

At receiver system 850, the transmitted modulated signals are received by N_{R} antennas 852a through 852r and the received signal from each antenna 852 is provided to a respective receiver (RCVR) 854a through 854r. Each receiver 854 conditions (e.g., filters, amplifies, and downconverts) a respective received signal, digitizes the conditioned signal to provide samples, and further processes the samples to provide a corresponding “received” symbol stream.

An RX data processor 860 then receives and processes the N_{R} received symbol streams from N_{R} receivers 854 based on a particular receiver processing technique to provide N_{T} “detected” symbol streams. The RX data processor 860 then demodulates, deinterleaves, and decodes each detected symbol stream to recover the traffic data for the data stream. The processing by RX data processor 860 is complementary to that performed by TX MIMO processor 820 and TX data processor 814 at transmitter system 810.

A processor 870 periodically determines which pre-coding matrix to use. Processor 870 formulates a reverse link message comprising a matrix index portion and a rank value portion.

The reverse link message can comprise various types of information regarding the communication link and/or the received data stream. The reverse link message is then processed by a TX data processor 838, which also receives traffic data for a number of data streams from a data source 836, modulated by a modulator 880, conditioned by transmitters 854a through 854r, and transmitted back to transmitter system 810.

At transmitter system 810, the modulated signals from receiver system 850 are received by antennas 824, conditioned by receivers 822, demodulated by a demodulator 840, and processed by a RX data processor 842 to extract the reserve link message transmitted by the receiver system 850. Processor 830 then determines which pre-coding matrix to use for determining the beamforming weights then processes the extracted message.

Processors 830 and 870 can direct (e.g., control, coordinate, manage, etc.) operation at transmitter system 810 and receiver system 850, respectively. Respective processors 830 and 870 can be associated with memory 832 and 872 that store program codes and data. For example, processors 830 and 870 can perform functions described herein with respect to communicating over multiple paging channels to reduce signal load in a wireless network. Similarly, memory 832 and 872 can store instructions for executing the functionality or components, and/or related data.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for monitoring multiple paging channels at a mobile station (MS), comprising:
monitoring a primary paging channel and an optimized secondary paging channel to receive one or more signals from a base station;
processing overhead data messages received in signals over the primary paging channel; and
processing MS-specific messages received in signals over the optimized secondary paging channel.

2. The method of claim 1, further comprising receiving an assignment of one or more time slots over which to monitor the optimized secondary paging channel.

3. The method of claim 2, wherein the monitoring the primary paging channel is performed during a time period outside of the one or more time slots.

4. The method of claim 1, further comprising monitoring substantially all paging channels provided by the base station.

5. The method of claim 1, wherein the overhead data messages comprise at least one of system or network messages, and the MS-specific messages comprise at least one of paging messages or channel assignment messages.

6. An apparatus for monitoring multiple paging channels at a mobile station (MS), comprising:
at least one processor configured to:
monitor a primary paging channel and an optimized secondary paging channel to receive one or more signals from a base station;
process overhead data messages received in signals over the primary paging channel; and
process MS-specific messages received in signals over the optimized secondary paging channel; and
a memory coupled to the at least one processor.

7. The apparatus of claim 6, wherein the at least one processor is further configured to receive an assignment of one or more time slots over which to monitor the optimized secondary paging channel.

8. The apparatus of claim 7, wherein the at least one processor monitors the primary paging channel during a time period outside of the one or more time slots.

9. The apparatus of claim 6, wherein the at least one processor monitors substantially all paging channels provided by the base station.

10. The apparatus of claim 6, wherein the overhead data messages comprise at least one of system or network messages, and the MS-specific messages comprise at least one of paging messages or channel assignment messages.

11. An apparatus for monitoring multiple paging channels at a mobile station (MS), comprising:
means for monitoring a primary paging channel and an optimized secondary paging channel to receive one or more signals from a base station;
means for processing overhead data messages received in signals over the primary paging channel and MS-specific messages received in signals over the optimized secondary paging channel.

12. The apparatus of claim 11, further comprising means for receiving an assignment of one or more time slots over which to monitor the optimized secondary paging channel.

13. The apparatus of claim 12, wherein the means for monitoring monitors the primary paging channel during a time period outside of the one or more time slots.

14. The apparatus of claim 11, wherein the means for monitoring monitors substantially all paging channels provided by the base station.

15. The apparatus of claim 11, wherein the overhead data messages comprise at least one of system or network messages, and the MS-specific messages comprise at least one of paging messages or channel assignment messages.

16. A computer program product for monitoring multiple paging channels at a mobile station (MS), comprising:
a computer-readable medium, comprising:
code for causing at least one computer to monitor a primary paging channel and an optimized secondary paging channel to receive one or more signals from a base station;
code for causing the at least one computer to process overhead data messages received in signals over the primary paging channel; and
code for causing the at least one computer to process MS-specific messages received in signals over the optimized secondary paging channel.

17. The computer program product of claim 16, wherein the computer-readable medium further comprises code for causing the at least one computer to receive an assignment of one or more time slots over which to monitor the optimized secondary paging channel.

18. The computer program product of claim 17, wherein the code for causing the at least one computer to monitor monitors the primary paging channel during a time period outside of the one or more time slots.

19. The computer program product of claim 16, wherein the code for causing the at least one computer to monitor monitors substantially all paging channels provided by the base station.

20. The computer program product of claim 16, wherein the overhead data messages comprise at least one of system or network messages, and the MS-specific messages comprise at least one of paging messages or channel assignment messages.

21. A method for communicating over multiple paging channels from a base station, comprising:
generating one or more overhead messages;
transmitting the one or more overhead messages over a primary paging channel;
generating one or more mobile station (MS)-specific messages related to a MS; and
transmitting the one or more MS-specific messages over an optimized secondary paging channel.

22. The method of claim 21, wherein the transmitting the one or more MS-specific messages occurs during time slots allocated to the MS according to a slot cycle index.

23. The method of claim 21, further comprising transmitting legacy MS-specific messages for one or more legacy MSs over the primary paging channel.

24. The method of claim 21, wherein the optimized secondary paging channel is one of multiple optimized secondary paging channels over which the one or more MS-specific messages are transmitted.

25. An apparatus for communicating over multiple paging channels from a base station, comprising:
at least one processor configured to:
generate one or more overhead messages;
transmit the one or more overhead messages over a primary paging channel;
generate one or more mobile station (MS)-specific messages related to a MS; and
transmit the one or more MS-specific messages over an optimized secondary paging channel; and
a memory coupled to the at least one processor.

26. The apparatus of claim 25, wherein the at least one processor transmits the one or more MS-specific messages during time slots allocated to the MS according to a slot cycle index.

27. The apparatus of claim 25, wherein the at least one processor is further configured to transmit legacy MS-specific messages for one or more legacy MSs over the primary paging channel.

28. The apparatus of claim 25, wherein the optimized secondary paging channel is one of multiple optimized secondary paging channels over which the one or more MS-specific messages are transmitted.

29. An apparatus for communicating over multiple paging channels from a base station, comprising:
means for generating one or more overhead messages and one or more mobile station (MS)-specific messages related to a MS; and
means for transmitting the one or more overhead messages over a primary paging channel and transmitting the one or more MS-specific messages over an optimized secondary paging channel.

30. The apparatus of claim 29, wherein the means for transmitting transmits the one or more MS-specific messages during time slots allocated to the MS according to a slot cycle index.

31. The apparatus of claim 29, wherein the means for transmitting transmits legacy MS-specific messages for one or more legacy MSs over the primary paging channel.

32. The apparatus of claim 29, wherein the optimized secondary paging channel is one of multiple optimized secondary paging channels over which the one or more MS-specific messages are transmitted.

33. A computer program product for communicating over multiple paging channels from a base station, comprising:
a computer-readable medium, comprising:
code for causing at least one computer to generate one or more overhead messages;
code for causing the at least one computer to transmit the one or more overhead messages over a primary paging channel;
code for causing the at least one computer to generate one or more mobile station (MS)-specific messages related to a MS; and
code for causing the at least one computer to transmit the one or more MS-specific messages over an optimized secondary paging channel.

34. The computer program product of claim 33, wherein the code for causing the at least one computer to transmit the one or more MS-specific messages transmits the one or more MS-specific messages during time slots allocated to the MS according to a slot cycle index.

35. The computer program product of claim 33, wherein the computer-readable medium further comprises code for causing the at least one computer to transmit legacy MS-specific messages for one or more legacy MSs over the primary paging channel.

36. The computer program product of claim 33, wherein the optimized secondary paging channel is one of multiple optimized secondary paging channels over which the one or more MS-specific messages are transmitted.
